(19) United States
(12) Patent Application Publication
(10) Pub. No.: US 2013/0236046 A1
(43) Pub. Date: Sep. 12, 2013

(54) METHOD, SYSTEM, AND COMPUTER-READABLE MEDIUM FOR DETECTING LEAKAGE OF A VIDEO

(71) Applicants: Rajarathnam Nallusamy, Thuraiyur Taluk (IN); Sachin Mehta, Nagrota Bagwan (IN)

(72) Inventors: Rajarathnam Nallusamy, Thuraiyur Taluk (IN); Sachin Mehta, Nagrota Bagwan (IN)

(73) Assignee: INFOSYS LIMITED, Bangalore (IN)

(21) Appl. No.: 13/527,869

(22) Filed: Jun. 20, 2012

(30) Foreign Application Priority Data
Mar. 9, 2012 (IN) 898/CHE/2012

(51) Int. Cl. G06K 9/46

(52) U.S. Cl. 382/100

(57) ABSTRACT

The present invention relates to a computer-implemented method, system and computer readable medium for detecting source of leakage of a video. The method comprises processing a video by a processing device resulting a processed video, identifying at least one responsible user for safekeeping and/or distributing and/or screening the processed video, creating a watermark wherein the watermark comprises an information about an owner of the video, the responsible user, and at least one transaction information, embedding the watermark inside the processed video resulting a watermarked video, distributing the watermarked video to at least one consumer, and identifying the responsible user by extracting the watermark from a pirated copy of the watermarked video and extracting the information contained in the watermark from the watermarked video.

This application claims the benefit of Indian Patent Application Filing No. 898/CHE/2012, filed Mar. 9, 2012, which is hereby incorporated by reference in its entirety.

### FIELD

The present invention relates to the field of Multimedia Security. In particular, the present invention provides a computer-implemented method, system and computer readable medium for detecting source of leakage of a video.

### BACKGROUND

With the advancement of technology, media content have been migrated from analog to digital format. Although analog to digital transition has offered better user-experience and new means of content production, distribution, and monetization, it has made illegal reproduction and distribution of digital content easier. Piracy of digital media content is increasing day by day and is a major cause of worry for the digital content owners. Most of the piracy is resulting from insider leaks (employees of studio or theater or broadcaster or distributor) and outsider leaks (Internet, end consumer).

The ongoing distribution of digital media is managed by Digital Rights Management (DRM) based systems. DRM based systems ignore the Traditional Rights and Usages (TRU) of digital media users and hence, suffer from interoperability and mobility issues. To preserve the TRU of digital media users and combat piracy, digital watermarking based systems are proposed.

Video watermarking is an active area of research for last decade. A number of video watermarking algorithms are proposed by the researchers. These algorithms can be classified into two domains:

Pixel domain video watermarking—The watermark is embedded in the video frames by simple addition or bit replacement of selected pixels. These methods are computationally fast but less robust.

Transform domain video watermarking—The video frame is transformed and watermark is embedded in the transform coefficients. These methods are robust to common signal processing attacks like compression etc. but require high computational time.

The existing processes have limitations such as video watermarking based methods are unable to carry large amount of information such as a string containing owner's name, responsible person's name and transaction date reliably, existing video watermarking methods embed same watermark for all the instances (copies) of video, existing methods are unable to detect the consumer who violates the copyright chain (either through Insider Leaks or Outsider Leaks), and DRM based systems suffer from interoperability and mobility issues.

Thus, there is a need to overcome the problems of the existing technologies. Therefore, the present inventors have developed a computer-implemented method, system and computer-readable medium for detecting source of leakage of a video which would protect the videos from copyright infringement and also identify an illegal user of the video.

### SUMMARY

According to one aspect of the invention there is provided a computer implemented method executed by one or more computing devices for detecting source of leakage of a video. The method comprises the steps of processing a video by a processing device resulting a processed video, identifying at least one responsible user for safekeeping and/or distributing and/or screening the processed video, creating a watermark wherein the watermark comprises an information about owner of the video, the responsible user, and at least one transaction information; embedding the watermark inside the processed video resulting a watermarked video and distributing it to at least one consumer; and identifying the responsible user by extracting the watermark from the watermarked video and extracting the information contained in the watermark from a copy of the watermarked video.

According to another aspect of the invention there is provided a system for detecting source of leakage of a video. The system comprises a memory and a processor operatively coupled to the memory. The processor configured to perform the steps of processing a video by a processing device resulting a processed video, identifying at least one responsible user for safekeeping and/or distributing and/or screening the processed video, creating a watermark wherein the watermark comprises an information about an owner of the video, the responsible user, and at least one transaction information; embedding the watermark inside the processed video resulting a watermarked video and distributing it to at least one consumer; and identifying the responsible user by extracting the watermark from the watermarked video and extracting the information contained in the watermark from the watermarked video.

According to another aspect of the invention there is provided a computer-readable code stored on a non-transitory computer-readable medium that, when executed by a computing device, performs a method for detecting source of leakage of a video. The method comprises the steps of processing a video by a processing device resulting a processed video, identifying at least one responsible user for safekeeping and/or distributing and/or screening the processed video, creating a watermark wherein the watermark comprises an information about an owner of the video, the responsible user, and at least one transaction information; embedding the watermark inside the processed video resulting a watermarked video and distributing it to at least one consumer; and extracting the watermark from the watermarked video and identifying the responsible user extracting the information contained in the watermark from the watermarked video.

### BRIEF DESCRIPTION OF THE DRAWINGS

Features, aspects, and advantages of the present invention will be better understood when the following detailed description is read with reference to the accompanying drawings in which like characters represent like parts throughout the drawings, wherein:

FIG. 1 shows an environment in which the present invention can be practiced in accordance with an embodiment of the present invention;

FIG. 2 shows a flowchart depicting a method for detecting source of leakage of a video, in accordance with an embodiment of the present invention;

FIG. 3 shows a flowchart depicting a method for identifying outsider leak (internet) of a video, in accordance with an embodiment of the present invention;

FIG. 4 shows a generalized computer network arrangement, in one embodiment of the present technique; and

FIG. 5 shows an example of Test1.avi depicting the working of present framework in accordance with an embodiment of the present invention.

### DETAILED DESCRIPTION

While system and method are described herein by way of example and embodiments, those skilled in the art recognize that system and method for detecting source of leakage of a video are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

The term leakage is defined as an unauthorized or illegal use of an authorized or legal copy of a video.

Disclosed embodiments provide a computer-implemented method, system and computer readable medium for detecting source of leakage of a video. The present invention is provided a video fingerprinting for copyright protection of videos which means embedding of distinct watermark inside each copy of digital video supplied to different consumers such as Internet users, distributors, Screening Theatres, etc. The present invention is provided to detect the source of leakage for insider and outsider leak (through the Internet) of a video respectively. The present invention is provided to prevent the piracy resulting from the insider leaks whether inside studio or outside studio as well as from the outsider leaks resulting from internet (downloading videos) or through illegal copy from physical medium such as DVD.

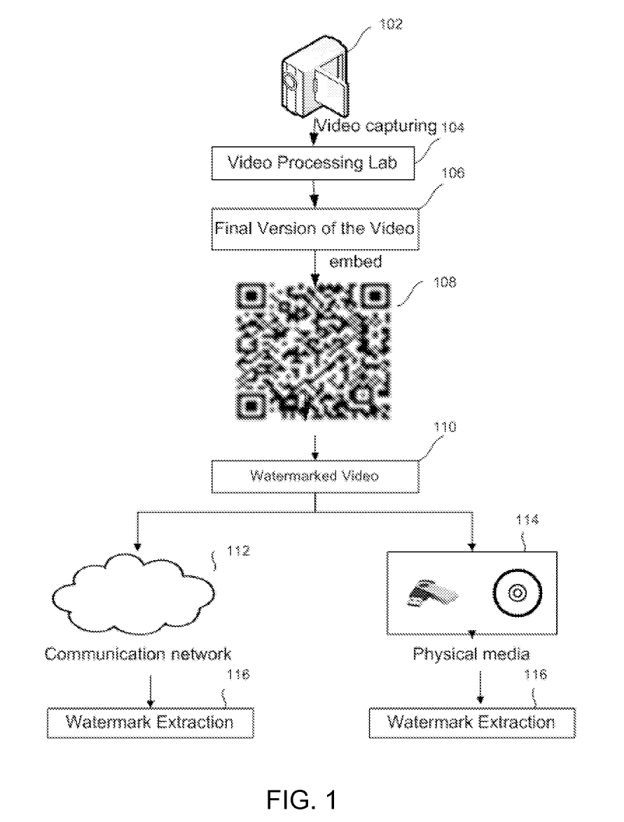

FIG. 1 shows an environment in which the present invention can be practiced, in accordance with an embodiment of the present invention. FIG. 1 includes a camera (102), which captures a video. The video which is captured from a camera is processed in a video processing lab (104). Not only captured video but also a video which is already existed or stored in a hard disk or compact disc may also be processed in a video processing lab. After processing, a final version of video or processed video (106) is generated. The processed video is embedded with a watermark (108) so that watermarked video (110) is generated. The watermarked video is distributed via a communication network (112) and/or a physical media (114). The consumer may distribute the watermarked video to other illegal consumers and hence violates the copyright chain. The pirated watermarked video can be obtained from the market or the Internet or other sources. The watermark from the pirated watermarked video is extracted (116) by the known ways in the art so as to identify the user whose copy of the video is the source for the pirated copy of the video.

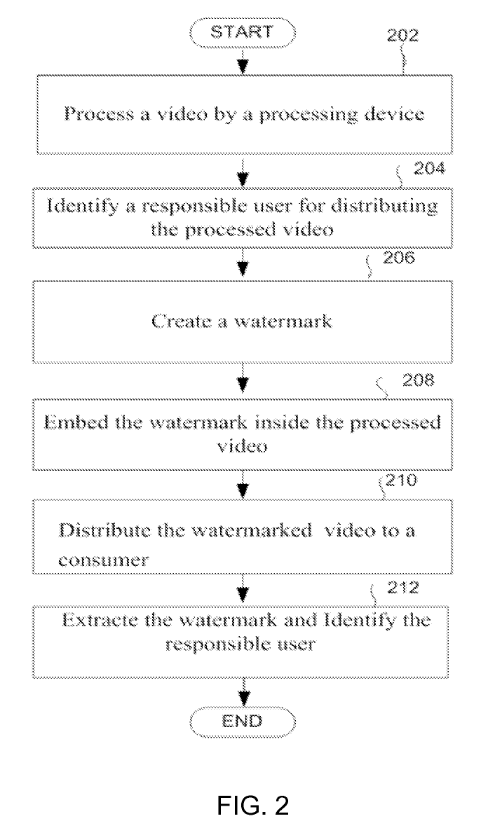

FIG. 2 shows a flowchart depicting a method for detecting source of leakage of a video. The method steps comprises that a raw video, which is captured by a camera, is processed inside the video processing lab and final version of video is created i.e. a video is processed by a processing device resulting a processed video (202). The final version of video (processed video) has to be distributed to various consumers such as critics, judges, theater/cinema, distributors, Internet users, etc. Whenever there is a transaction of video between owner and consumer, identify one person who will be responsible for the sharing or transmission or screening of the video. Therefore, identify a responsible user (204) who will be responsible for the sharing or transmission or screening of the processed video. After that, create a watermark (206) i.e. create a string which contains the information about the owner, responsible person and transaction information and convert it into QR code (watermark). In case of downloading video from Internet, string will contain information about the owner, user name, the server's IP address from where video is downloaded and other transaction information such as Session-ID. In another way to say that the created watermark comprises information about an owner of the video, the responsible user, and transaction information. The transaction information comprises a transaction id and/or a session id and/or a time stamp. The watermark is embedded (208) inside the processed video which results into a watermarked video. Distribute the watermarked video (210) to at least one consumer. The consumer may distribute this video to illegal consumers. Obtain the pirated video and extract the watermark (212) from the pirated video and also extract the information contained in the watermark from the pirated video thereby identify the responsible user whose copy is the source of illegal or pirated copy of the video.

The present method embeds a distinct watermark for each instance of video whenever a transaction occurs between owner of the video and the consumer. The watermark contains the information about the owner of the video and the responsible person (user ID in case of Internet users). This information can be recovered from the illegal copy which is created by imitating the watermarked video and can be used for detecting the source copy of the piracy as well as for establishing the owner's rights over the video.

For an example, suppose a copy of the final version of a video is used for screening to critics, judges, etc. after watermarking it with the owner's information, information about the person responsible for this screening, and other transaction details such as time-stamp. Suppose a pirated copy of the video is subsequently available in the market in form of CD, DVD, etc., b uy that illegal copy and extract the hidden watermark from the video. The extracted watermark contains the information about the responsible person and hence, owner will be able to detect the consumer who violated the copyright chain by distributing the content to illegal consumers and /or unauthorized consumers.

Selection of a watermark is very crucial in digital watermarking applications. In the proposed scheme, QR code is chosen as a watermark because of the following features:

i) Small in size—QR code is a two-dimensional barcode which is capable of carrying large amount of information in small space.

ii) Noise and damage resistant—QR code utilizes Reed-Solomon (RS) codes to protect the data from noise and damage. There are four error correction levels in QR codes: Level L, Level M, Level Q and Level H. Level L have least error correction capability (7%) while Level H has highest error correction capability (30%). With the increase in level, there is an increase in the error correction capability but also a decrease in information carrying capacity. For example, Version 4 of QR code having Level H can carry 50 alphanumeric characters while for the same version, Level L carries 114 alphanumeric characters.

These features of QR code helps in achieving watermarking requirements, robustness and capacity, without any extra processing. The watermark which is used in the present invention can also be a barcode or an image.

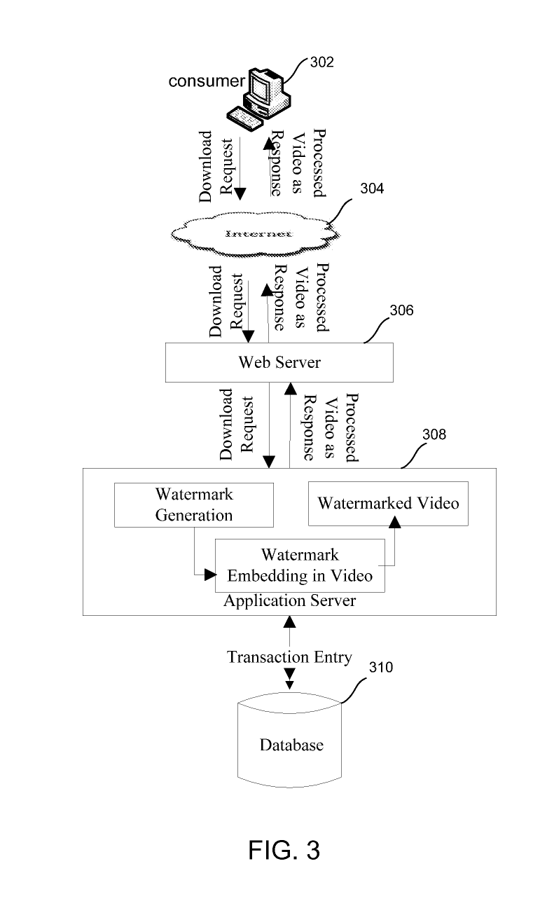

FIG. 3 shows a method for identifying outsider leak (Internet). In case of downloading video from Internet, as shown in FIG. 3, sending a download request from a computer (302) to Internet or World Wide Web (304) for a video. Then, that download request reaches Web server (306) through a network. The Web server is operatively connected to an application server (308) and it receives the download request through a network. The application server generates the watermark as per the user's credentials and processes the video “on-the-fly” to generate the watermarked copy. The application server is further operatively coupled to a database (310). The database comprises the information such as owner of the video, the responsible user, and transaction information, which are used for generating the watermark. The transaction information in the database comprises a transaction id and/or a session id and/or a time stamp and/or machine id from where the request originated. After persisting the transaction and other details in the database, the application server sends the processed video to a Web server. From there, the video passes to Internet and finally reaches the requester who sent the download request for the video.

### Exemplary Computing Environment

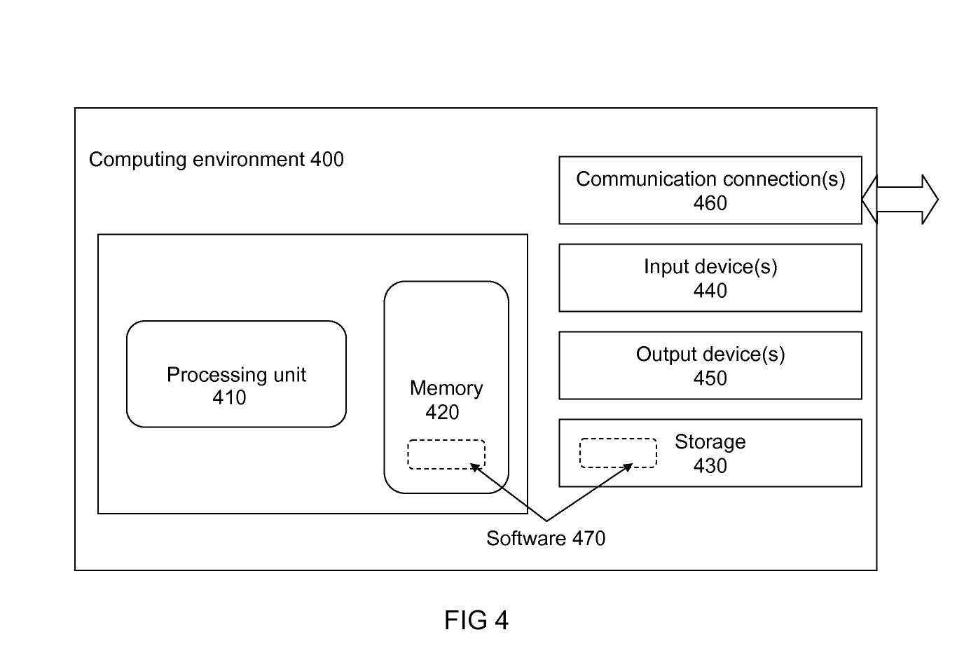

One or more of the above-described techniques may be implemented in or involve one or more computer systems. FIG. 4 shows a generalized example of a computing environment 400. The computing environment 400 is not intended to suggest any limitation as to scope of use or functionality of described embodiments.

With reference to FIG. 4, the computing environment 400 includes at least one processing unit 410 and memory 420. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 470 implementing described techniques.

A computing environment may have additional features. For example, the computing environment 400 includes storage 430, one or more input devices 440, one or more output devices 450, and one or more communication connections 460. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 430 may be removable or non-removable, and includes magnetic disks, magnetic tapes or cassettes, CD-ROMs, CD-RWs, DVDs, or any other medium which may be used to store information and which may be accessed within the computing environment 400. In some embodiments, the storage 430 stores instructions for the software 470.

The input device(s) 440 may be a touch input device such as a keyboard, mouse, pen, trackball, touch screen, or game controller, a voice input device, a scanning device, a digital camera, or another device that provides input to the computing environment 400. The output device(s) 450 may be a display, printer, speaker, or another device that provides output from the computing environment 400.

The communication connection(s) 460 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 400, computer-readable media include memory 420, storage 430, communication media, and combinations of any of the above.

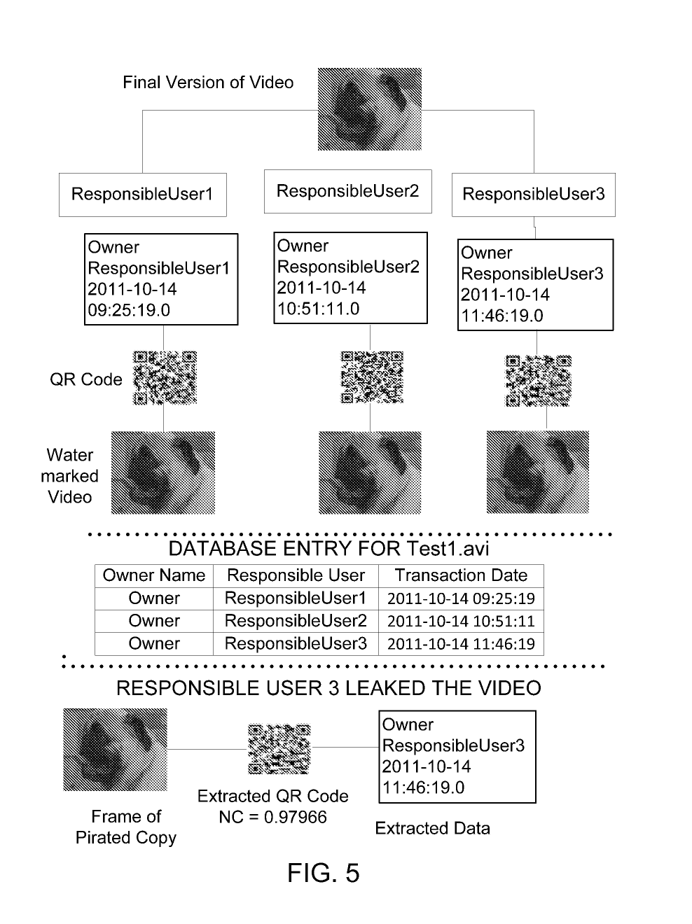

For example, a video, named Test1.avi is chosen to show the working of present framework as shown in FIG. 5. As described hereinabove, the responsible person is chosen if there is a transaction between source (Owner of the content) and consumer (Screening Media, Theaters and Distributors). The name of the responsible person is concatenated along with the name of the owner of the audio-visual content and timestamp information. QR code, watermark, is constructed from this information. This watermark is then embedded inside the video. This watermarked video is treated as the final version of the video and is shared with the consumers. Now, if there is any leakage of the watermarked video, then the source of leakage can be detected by extracting the watermark. FIG. 5 illustrates the working of proposed method. In FIG. 5, it is assumed that responsible user 3 has leaked the video. The pirated copy is obtained from the market and watermark is extracted. It can be seen in FIG. 5 that the extracted data contains “responsible user 3” and “owner” as covert message. Hence, “responsible user 3” is responsible for violating the copyright chain and owner of video can take actions (legal, fine punishment, etc.) against responsible user 3.

Having described and illustrated the principles of our invention with reference to described embodiments, it will be recognized that the described embodiments may be modified in arrangement and detail without departing from such principles.

In view of the many possible embodiments to which the principles of our invention may be applied, we claim as our invention all such embodiments as may come within the scope and spirit of the claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The detailed description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed:

1. A computer implemented method executed by one or more computing devices for detecting source of leakage of a video, the method comprising:
processing a video by a processing device resulting in a processed video;
identifying at least one responsible user for at least one of safekeeping, distributing, or screening the processed video;
creating a watermark wherein the watermark comprises information about an owner of the video, the responsible user, and at least one transaction;
embedding the watermark inside the processed video resulting in a watermarked video;
distributing the watermarked video to at least one consumer; and
identifying the responsible user by extracting the watermark from the watermarked video and extracting the information contained in the watermark from the watermarked video.

2. The method of claim 1 further comprising storing the information contained in the watermark in a database.

3. The method of claim 1, wherein the watermark is at least one of a quick response code, a barcode, or an image.

4. The method of claim 1, wherein the transaction information comprises at least one of a transaction id, a session id, or a time stamp.

5. The method of claim 1, wherein the distributing further comprises distributing the video through at least one of a network means or a computer readable medium.

6. A system for detecting source of leakage of a video, the system comprising:
a memory; and
a processor operatively coupled to the memory, the processor configured to perform the steps of:
processing a video by a processing device resulting in a processed video;
identifying at least one responsible user for at least one of safekeeping, distributing, or screening the processed video;
creating a watermark wherein the watermark comprises information about an owner of the video, the responsible user, and at least one transaction;
embedding the watermark inside the processed video resulting in a watermarked video;
distributing the watermarked video to at least one consumer; and
identifying the responsible user by extracting the watermark from the watermarked video and extracting the information contained in the watermark from the watermarked video.

7. The system of claim 6 further comprising a database wherein the database comprises the information contained in the watermark.

8. The system of claim 6, wherein the watermark is at least one of a quick response code, a barcode, or an image.

9. The system of claim 6, wherein the transaction information comprises at least one of a transaction id, a session id, or a time stamp.

10. The system of claim 6, wherein the distributing further comprises distributing the video through at least one of a network means or a computer readable medium.

11. Computer-readable code stored on a non-transitory computer-readable medium that, when executed by a computing device, performs a method for detecting source of leakage of a video, the method comprising:
processing a video by a processing device resulting in a processed video;
identifying at least one responsible user for at least one of safekeeping, distributing, or screening the processed video;
creating a watermark wherein the watermark comprises information about an owner of the video, the responsible user, and at least one transaction;
embedding the watermark inside the processed video resulting in a watermarked video;
distributing the watermarked video to at least one consumer; and
identifying the responsible user by extracting the watermark from the watermarked video and extracting the information contained in the watermark from the watermarked video.

12. The computer-readable medium of claim 11 further comprising a database wherein the database comprises the information contained in the watermark.

13. The computer-readable medium of claim 11, wherein the watermark is at least one of a quick response code, a barcode, or an image.

14. The computer-readable medium of claim 11, wherein the transaction information comprises at least one of a transaction id, a session id, or a time stamp.

15. The computer-readable medium of claim 11, wherein the distributing further comprises distributing the video through at least one of a network means or a computer readable medium.
